(19) United States
(12) Patent Application Publication
(10) Pub. No.: US 2026/0368677 A1
(43) Pub. Date: Nov. 19, 2026

(54) AUTOMATING REQUEST FOR PROPOSAL (RFP) RESPONSE GENERATION

(71) Applicant: Schlumberger Technology Corporation, Sugar Land, TX (US)

(72) Inventors: Dhruv Tewari, Pune (IN); Aditya Kotiyal, Lysaker (NO)

(21) Appl. No.: 19/662,751

(22) Filed: Apr. 29, 2026

(30) Foreign Application Priority Data
May 16, 2025 (IN) 202511047375

(51) Int. Cl. G06Q 10/0637; G06Q 50/18

(52) U.S. Cl. CPC G06Q 10/0637; G06Q 50/18

(57) ABSTRACT

A method for generating a response to a request for proposal (RFP) includes receiving the RFP; processing the RFP using a first machine learning model (MLM) to produce a processed RFP; generating, by a multi-agent system, a structured executive response summary based at least on the processed RFP; generating, by the multi-agent system, a draft RFP response based on the structured executive response summary; and generating a finalized RFP response by verifying and refining the draft RFP response using a second MLM.

### CROSS-REFERENCE TO RELATED APPLICATIONS

This application claims priority to Indian Provisional Patent Application No. 202511047375, filed on May 16, 2025, which is incorporated by reference.

### BACKGROUND

Creating a request for proposal (RFP) response is a long and labor-intensive process that often takes weeks or even months to complete. It involves coordinating across multiple teams, ensuring compliance with complex standards, and manually crafting detailed responses. This drafting also has repetitive work, as many sections of RFP responses—such as company overviews, technical capabilities, and pricing models—are similar across different proposals in terms of contextual understanding. This manual approach consumes valuable time and increases the risk of errors and inconsistencies. Therefore, what is needed is an improved system and method for automating and enhancing the creation of a proposal.

### SUMMARY

In an aspect of the present disclosure, a method for generating a response to a request for proposal (RFP) is provided. The method includes receiving the RFP. The method further includes processing the RFP using a first machine learning model (MLM) to produce a processed RFP. The method further includes generating, by a multi-agent system, a structured executive response summary based at least on the processed RFP. The method further includes generating, by the multi-agent system, a draft RFP response based on the structured executive response summary. The method further includes generating a finalized RFP response by verifying and refining the draft RFP response using a second MLM.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates example components of a system configured for generating a response to a request for proposal (RFP), according to an embodiment.

FIG. 3 illustrates a flowchart of an example method for processing RFP information, according to an embodiment.

FIGS. 4A and 4B illustrate an example architectural flow for generating a response to an RFP, according to an embodiment.

FIG. 5 illustrates a flowchart of an example method for generating a response to an RFP, according to an embodiment.

FIG. 6 illustrates an example user interface (UI) for receiving custom inputs from a user for generating a response to an RFP, according to an embodiment.

FIGS. 7A, 7B, and 8-11 illustrate example content portions in a generated RFP response document, according to an embodiment.

FIG. 12 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

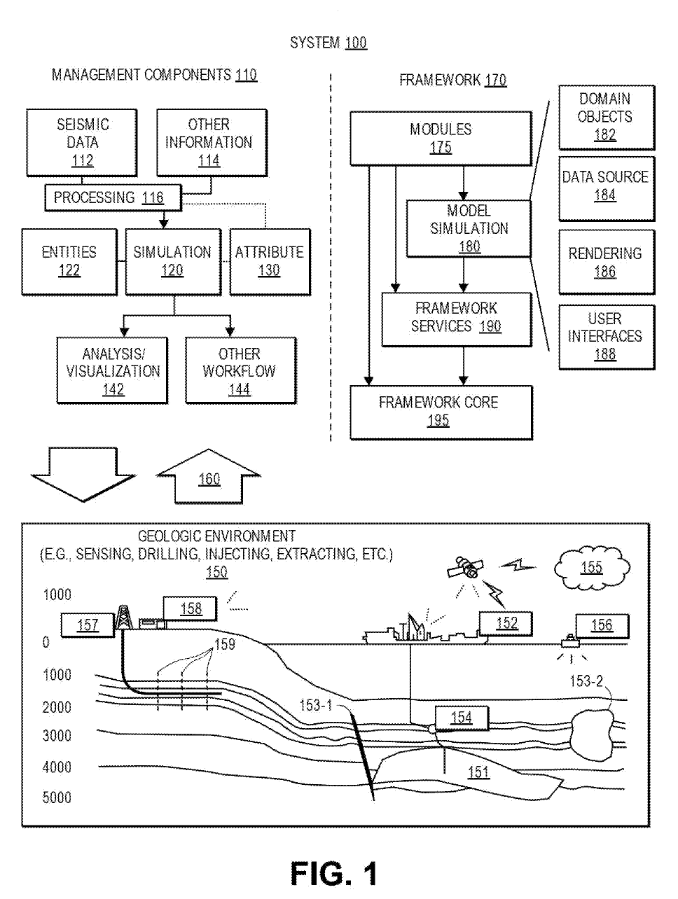

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 may include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT^{®} .NET^{®} framework (Redmond, Washington), which provides a set of extensible object classes. In the .NET^{®} framework, an object class encapsulates a module of reusable code and associated data structures. Object classes may be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE^{TM} reservoir simulator (SLB, Houston Texas), the INTERSECT^{TM} reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

As an example, the simulation component 120 may include one or more features of a simulator such as SYMMETRY software (SLB, Houston, Texas). More particularly, SYMMETRY may process workflows in a single integrated environment with accurate thermodynamic fluid representation and consistent modeling across multiple disciplines including process, production, and HSE. The simulator integrates steady-state and transient (e.g., dynamic) analyses that may be tailored for each domain. This approach enables users to optimize processes in upstream, midstream, and downstream sectors while maximizing profits and minimizing capital expenditures. It may also help reduce emissions, energy consumption, and waste.

As an example, the simulation component 120 may include one or more features of a simulator such as PIPESIM (SLB, Houston, Texas). More particularly, PIPESIM is steady-state multiphase flow simulator that incorporates the three areas of flow modeling: multiphase flow, heat transfer and fluid behavior.

As an example, the simulation component 120 may include one or more features of a simulator such as OLGA™ (SLB, Houston, Texas). More particularly, OLGA™ is a dynamic multiphase flow simulator that models transient flow (e.g., time-dependent behaviors) to maximize production potential. Transient modeling is a component for feasibility studies and field development design. Dynamic simulation is useful in deep water and is used in both offshore and onshore developments to investigate transient behavior in pipelines and wellbores. Transient simulation with the OLGA™ simulator provides an added dimension to steady-state analysis by predicting system dynamics, such as time-varying changes in flow rates, fluid compositions, temperature, solids deposition, and operational changes.

In an example embodiment, the management components 110 may include features of a commercially available framework such as the PETREL^{®} seismic to simulation software framework (SLB, Houston, Texas). The PETREL^{®} framework provides components that allow for optimization of exploration and development operations. The PETREL^{®} framework includes seismic to simulation software components that may output information for use in increasing reservoir performance, for example, by improving asset team productivity. Through use of such a framework, various professionals (e.g., geophysicists, geologists, and reservoir engineers) may develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN^{®} framework environment (SLB, Houston, Texas) allows for integration of add-ons (or plug-ins) into a PETREL^{®} framework workflow. The OCEAN^{®} framework environment leverages .NET^{®} tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN^{®} framework where the model simulation layer 180 is the commercially available PETREL^{®} model-centric software package that hosts OCEAN^{®} framework applications. In an example embodiment, the PETREL^{®} software may be considered a data-driven application. The PETREL^{®} software may include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications may display their data while the user interfaces 188 may provide a common look and feel for application user interface components.

As an example, the domain objects 182 may include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project may be accessed and restored using the model simulation layer 180, which may recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL^{®} software, for example, that operates on seismic data, seismic attribute(s), etc. As an example, a workflow may be a process implementable in the OCEAN^{®} framework. As an example, a workflow may include one or more worksteps that access a module such as a plug-in (e.g., external executable code, etc.).

### Automating RFP Response Generation

The automatic RFP response generation method described herein develops a minimum viable product (MVP) for RFP response generation, which may automate the proposal creation process, leading to a good first base of the proposal. By leveraging advanced large language models (LLMs), the present aspects use information from request documents, match it with relevant product details, and generate structured, professional proposal drafts. This automation may reduce human effort, aid the strenuous process, and accelerate the proposal lifecycle.

The automatic RFP response generation method according to the present aspects may deliver a working prototype that may be used to create well-aimed, comprehensive RFP responses efficiently. This MVP may lay the foundation for a fully automated method that may scale to handle complex proposal standards while maintaining a dedicated standard. By reducing manual effort and enhancing productivity, the method may allow teams to focus on strategic tasks, ultimately improving the chances of winning new business opportunities.

The automatic RFP response generation method according to the present aspects automates the generation of RFP responses by using updated information of different products. The method automatically matches the standards with relevant products available in a database and then generates a proposal to give a unique landing for a good start to BDMs and AMs.

As compared to conventional RFP generation, the automatic RFP response generation method according to the present aspects maintains a product database and connects these databases with relevant images. The pre-context of what is generated may be taken into consideration with a top product matching algorithm and an image selection algorithm to generate the RFP response document.

The automatic RFP response generation method according to the present aspects may have one or more functional impacts including accelerated RFP response delivery. More particularly, the method may generate a draft-ready RFP response in hours instead of weeks, allowing for quicker client engagement and faster project initiation. The method also improves operational efficiency. More particularly, streamlined processes reduce bottlenecks, enabling teams to manage multiple RFPs simultaneously. The method also reduces labor costs. More particularly, automation decreases manual content creation, reducing human resource expenses. The method also minimizes errors and rework. AI-driven content creation improves accuracy, reducing the likelihood of mistakes.

The automatic RFP response generation method according to the present aspects may also have one or more non-functional impacts including improved quality and consistency. The use of AI ensures that each proposal is formatted consistently and adheres to best practices, enhancing the professionalism of submissions. The method also provides knowledge retention. More particularly, the method captures and organizes responses, building a centralized knowledge repository and structured formatting.

The automatic RFP response generation method according to the present aspects may provide RFP summarization, for example, using LangChain® and Dataiku’s LLM mesh to process extracted content. The method also provides automated response generation. More particularly, the method uses input text data in a Streamlit® application itself to generate professional documents using a python-docx library. The method may also support advanced formatting (e.g., custom fonts, aligned images, and tailored content based on prompts and product database information). The method may also provide dynamic progress tracking. More particularly, users may see real-time progress updates during RFP processing and document generation.

In an example, the automatic RFP response generation method according to the present aspects may use Streamlit®, which may provide a user-friendly and interactive web interface, as well as enable rapid prototyping and deployment of data applications. The method may also use Dataiku®, which may serve as the core platform for hosting the Streamlit® application via its webapp feature. It may leverage Dataiku’s® LLM mesh for secure, in-house large language model (LLM) access. It may also ensure robust deployment with access controls and enterprise-grade security. The method may also use LangChain® to interact with and process documents using Dataiku’s® LLM mesh. It supports complex prompt engineering via PromptTemplate and create_stuff_documents_chain for improved summarization and RFP response generation.

The automatic RFP response generation method according to the present aspects may use Python® libraries such as: python-docx (for generating editable Word® documents containing detailed proposal responses), pandas (for handling structured data within the RFP workflow), PyMuPDF (fitz) and Unstructured (for loading and parsing PDF and Word® documents), Pydantic (for data validation and schema definition, ensuring accurate input handling), PIL (Pillow, for handling and embedding images into generated documents), json_repair (for fixing and processing incomplete or malformed JSON outputs), Langchain® (for chained prompts and bigger context handling), and Dataiku® (for connecting with Dataiku folders and LLM).

The automatic RFP response generation method according to the present aspects may have feature infrastructure usage. More particularly, the method may have no external API exposure (i.e., the app is not exposed as an API outside). The method may provide internal Dataiku® managed folder access. More particularly, images may be accessed securely from the internal file system (e.g., imagedb/) created within Dataiku®. No public API may be called for fetching any information from the net. No RFP input or response generation storage may be used.

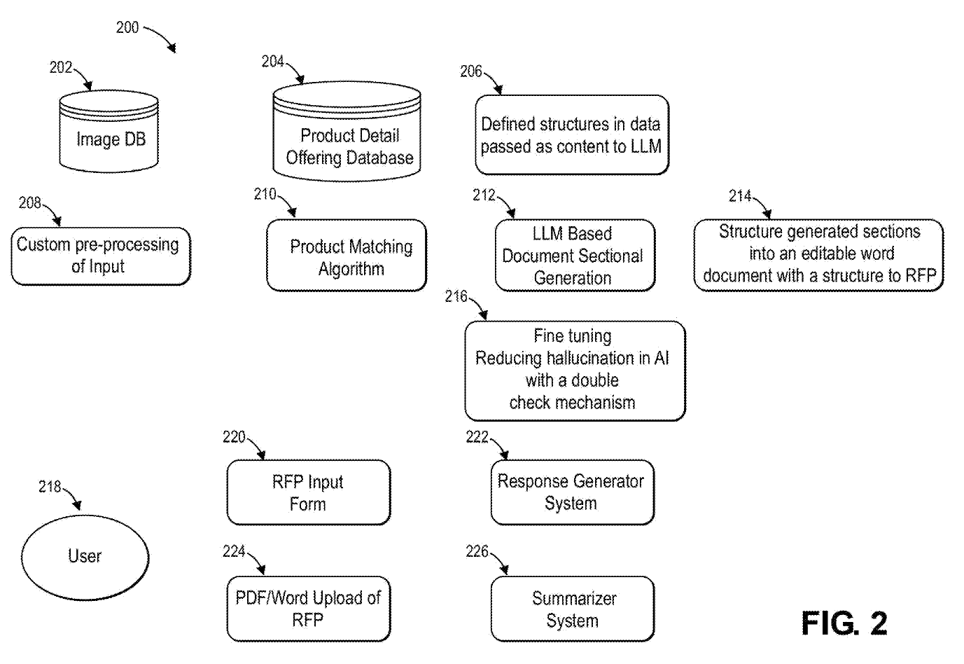

FIG. 2 illustrates example components of a system 200 configured for generating a response to an RFP, according to an embodiment. In the system 200, a user 218 may use an RFP input form 220 to enter RFP information and upload the PDF/Word of RFP 224. The system 200 performs custom pre-processing of the input 208, and defined structures in the data are passed as content to an LLM 206. The system 200 then executes a summarizer system 226 to generate an executive summary, and executes a response generator system 222 to generate an RFP response. The summarizer system 226 and the response generator system 222 may each execute one or more of the below-described components of the system 200.

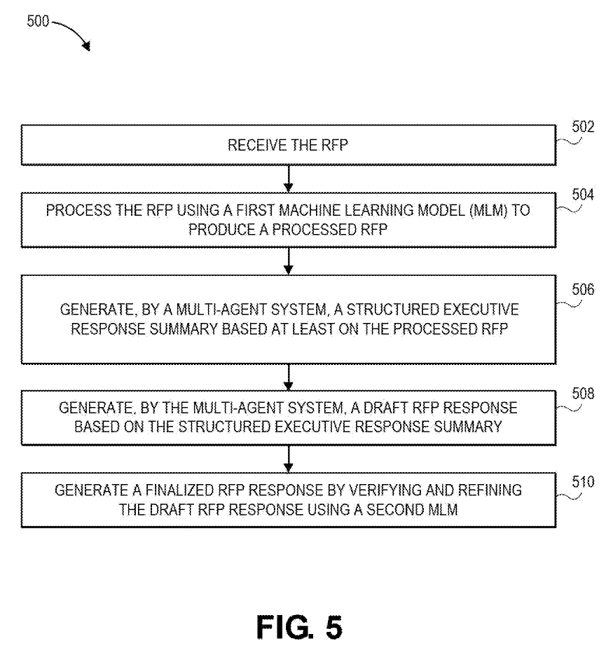

Specifically, the system 200 performs LLM-based document sectional generation 212, and uses a product matching algorithm 210 to identify products in a product detail offering database 204 that are related to the RFP, and corresponding images in an image database 202. The image database 202 includes images of products provided by a company, and the product detail offering database 204 includes detailed description of products provided by the company. The system 200 structures the generated sections into an editable Word document with a structure to RFP 214, and performs fine tuning reducing hallucination in AI with a double check mechanism 216. Some further example details of these aspects are described below with reference to FIG. 5.

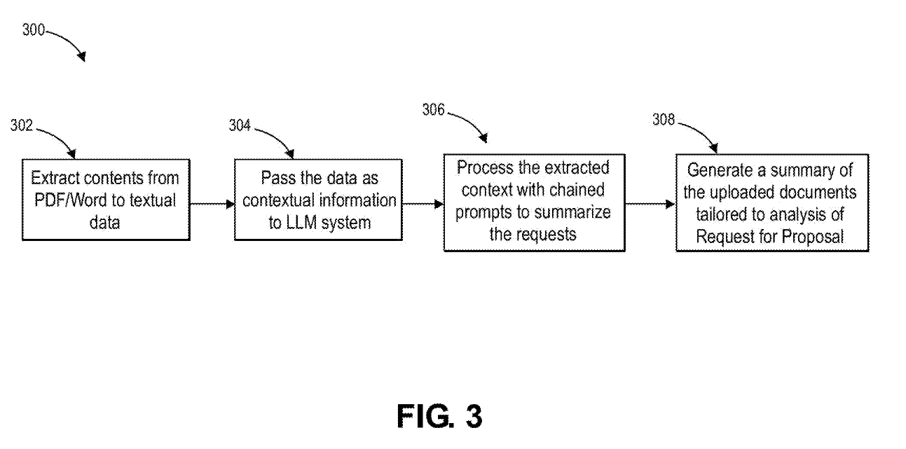

FIG. 3 illustrates a flowchart of an example method 300 for processing RFP information, according to an embodiment. At 302, content is extracted from PDF/Word to textual data. At 304, the data is passed as contextual information to an LLM system. At 306, the extracted content is processed with chained prompts to summarize the requests in the RFP. At 308, a summary of the uploaded documents tailored to analysis of RFP is generated, aiming to identify crucial deadlines, business requests, and any critical information for a BDM responding to the RFP. Some further example details of these aspects are described below with reference to FIG. 5.

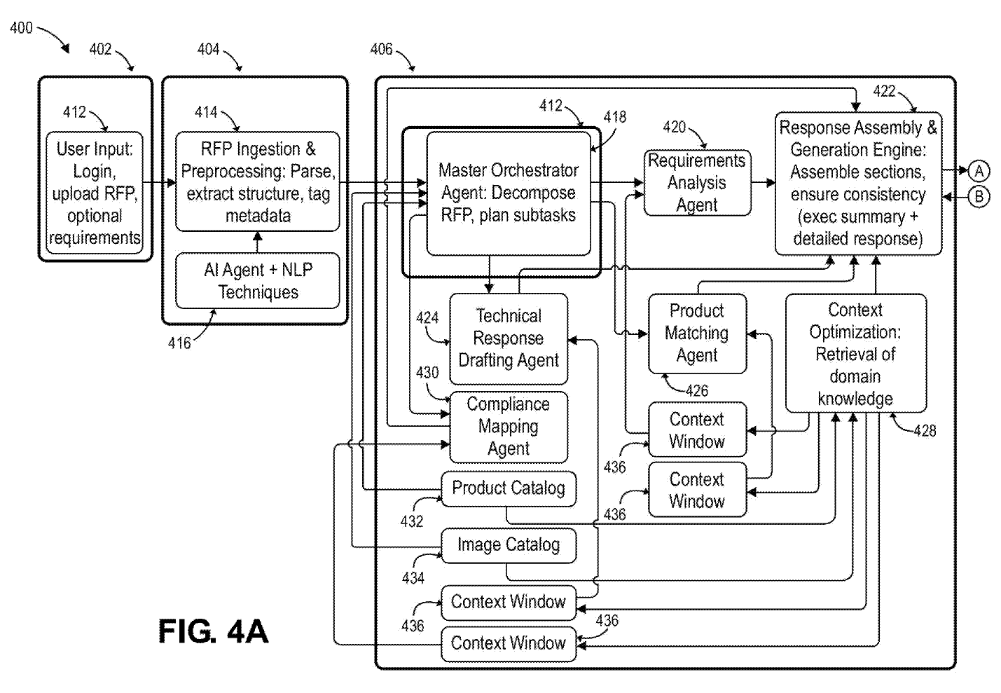

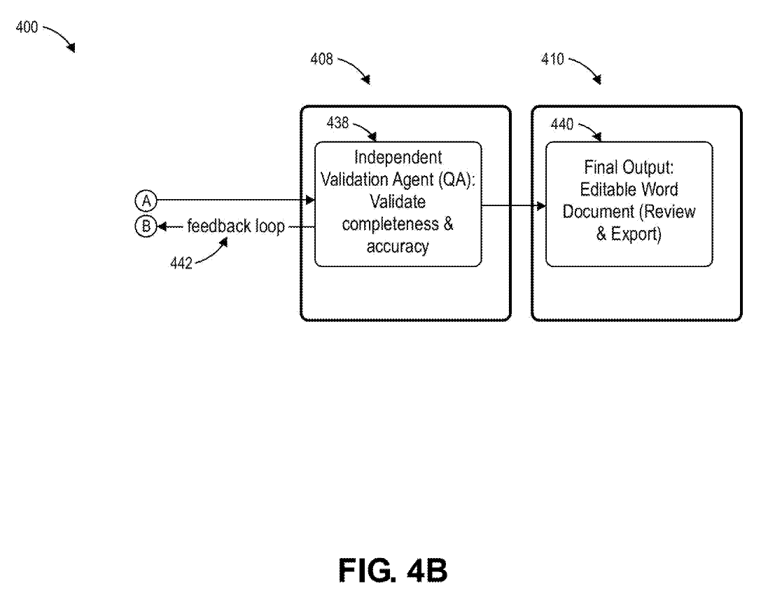

FIGS. 4A and 4B illustrate an example architectural flow 400 for generating a response to an RFP, according to an embodiment. The architectural flow 400 includes an input stage 402, a data ingestion stage 404, an execution stage 406, a validation stage 408, and an output stage 410. The input stage 402 includes reception of user input 412 such as login, RFP upload, and optional requirements. The ingestion stage 404 includes RFP ingestion and pre-processing 414 to parse, extract structures, and tag metadata, using AI agents and NLP techniques 416. The execution 406 stage 406 includes orchestration 412 by a master orchestrator agent 418 that decomposes the RFP and plans subtasks for a requirements analysis agent 420, a technical response drafting agent 424, a compliance mapping agent 430, and a product matching agent 426, each receiving input through a respective context window 436 that in turn receives input from a context optimization component 428 that provides retrieval of domain knowledge from a product catalog 432 and an image catalog 434. A response assembly and generation engine 422 assembles the generated sections and ensures consistency of the executive summary and the detailed response. The validation stage 408 includes an independent validation agent 438 (QA) that validates completeness and accuracy, and may perform one or more iterations via a feedback loop 442. The output stage 410 includes a final output 440 that is an editable Word document that is ready for review and export. Some further example details of these aspects are described below with reference to FIG. 5.

As mentioned above, the automatic RFP response generation method according to the present aspects may automate the process of generating response-ready drafts with precision and efficiency. Using contextual analysis of the RFP, the method may intelligently interpret standards and leverage a custom workflow to identify the most suitable products.

The automatic RFP response generation method according to the present aspects goes beyond conventional template-based methods. More particularly, the method fine-tunes prompts using advanced natural language processing (NLP) techniques and generative AI (GenAI) capabilities to eliminate hallucinations that may arise in generic AI models. To further enhance accuracy, the method may employ a double-check generation mechanism, where an initial draft is generated and subsequently analysed by a secondary LLM. This LLM acts as both a reviewer and regenerator, identifying inconsistencies, correcting errors, and regenerating sections. This iterative refinement ensures that the final output is both precise and contextually relevant.

Additionally, the automatic RFP response generation method according to the present aspects enhances the proposal by identifying and integrating relevant product images at selected (e.g., optimal) placements within the document. This strategic positioning enables business development managers (BDMs) to efficiently utilize the generated document with minimal edits, streamlining their workflow.

The automatic RFP response generation method according to the present aspects is not merely a template generator—it is an intelligent solution that comprehends standards, accurately matches products, and follows a structured flow to generate comprehensive proposals. Moreover, the method develops a robust, scalable database for both product information and images. This modular design enables seamless plug-and-play functionality, allowing new products to be easily integrated into the system.

In an example, a user may have 2200 RFP yearly, an average time to respond of 90 hours, and a success rate of 30%. In the example, the potential RFP tender cost may range from $8 million USD to $12 million USD on average. Even 10 minutes saved per RFP will yield a capability of generating responses for 4 more RFP in a year which may result in a potential increase in revenue of millions of dollars.

### Exemplary Method

FIG. 5 illustrates a flowchart of an example method 500 for generating a response to a request for proposal (RFP), according to an embodiment. An illustrative order of the method 500 is provided below; however, one or more portions of the method 500 may be performed in a different order, simultaneously, repeated, or omitted. At least a portion of the method 500 may be performed using a computing system.

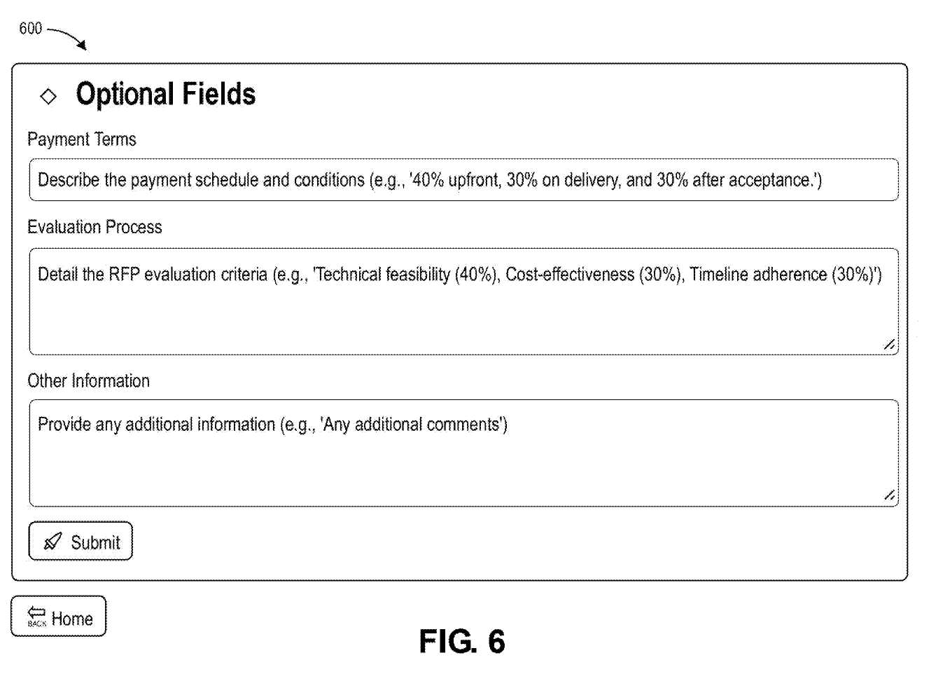

The method 500 may include receiving the RFP at 502, e.g., from the user 218 via RFP input form 220 and PDF/Word upload of RFP 224. The RFP may be related to an energy industry. The energy industry may include exploration, drilling, and/or production. The RFP may be received in natural language. The RFP may be in text or a portable document format (PDF). The RFP may be adaptable to different industries and may be configurable for varying requirements. FIG. 6 illustrates an example user interface (UI) 600 for receiving custom inputs (e.g., RFP input form 220) from the user 218 for generating a response to an RFP, according to an embodiment.

The method 500 may further include processing the RFP using a first machine learning model (MLM) to produce a processed RFP at 504. For example, RFP ingestion and pre-processing 414 is performed to parse, extract structures, and tag metadata, using AI agents and NLP techniques 416 in the data ingestion stage 404. The first MLM may include a combination of large language model (LLM) techniques and machine learning methods. The first MLM may apply NLP techniques to perform a contextual analysis on the RFP and uses chained prompting to parse the RFP, extract structured requirements from the RFP, and tag metadata in the RFP. The extracted structured requirements may include functional requirements, financial requirements, and deadline requirements in the RFP and/or in the information received via the RFP input form 220.

The method 500 may further include generating, by a multi-agent system, a structured executive response summary based at least on the processed RFP at 506, e.g., during the execution stage 406. In some aspects, generating the structured executive response summary is further based on a database that includes a product catalogue (e.g., the product catalogue 432) and an image catalogue (e.g., the image catalogue 434) of a vendor. In some aspects, an image in the image catalogue may be associated with metadata that associates the image with a product in the product catalogue. The metadata may further include a textual explanation of the image.

The method 500 may further include generating, by the multi-agent system, a draft RFP response based on the structured executive response summary at 508. For example, in the execution stage 406, a multi-agent system may first generate the structured executive response summary and then use it to generate a draft RFP response. Further details of the multi-agent system are described below with reference to example embodiments.

The method 500 may further include generating a finalized RFP response by verifying and refining the draft RFP response using a second MLM at 510. For example, in the validation stage 408, an independent validation agent 438 (QA) validates completeness and accuracy and may perform one or more iterations via a feedback loop 442.

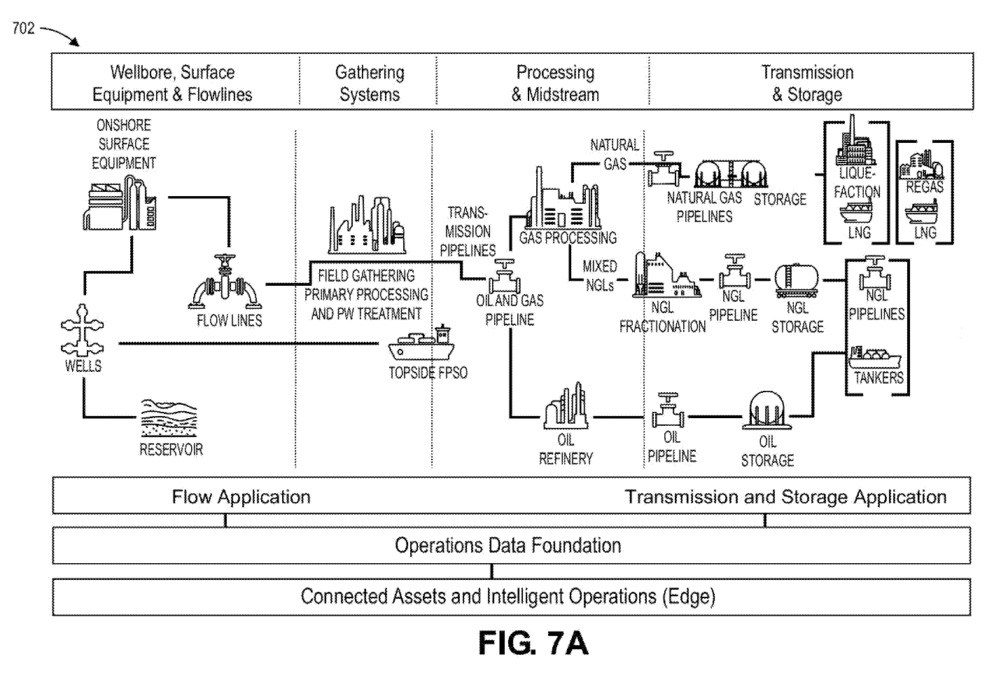

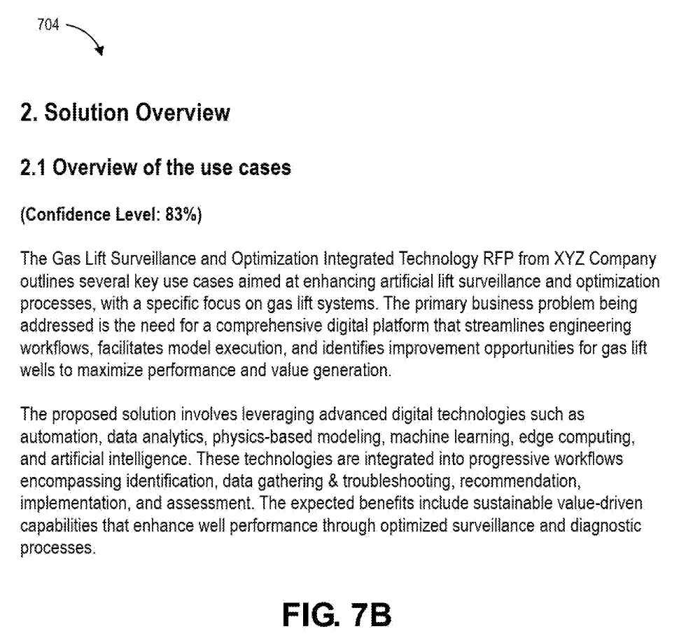

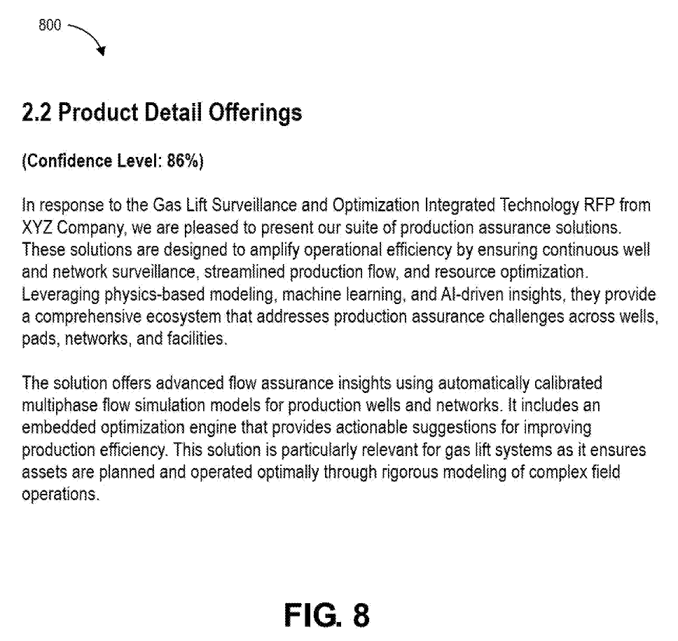

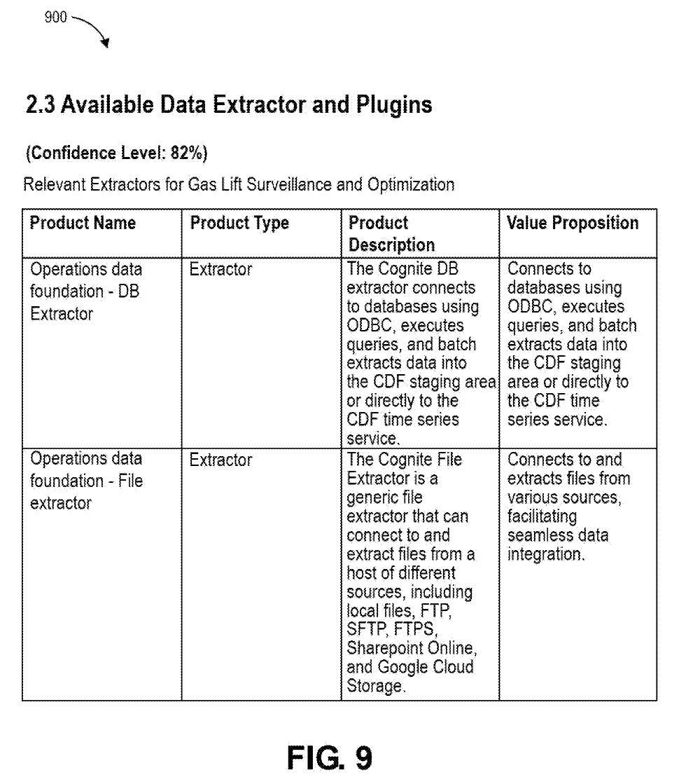

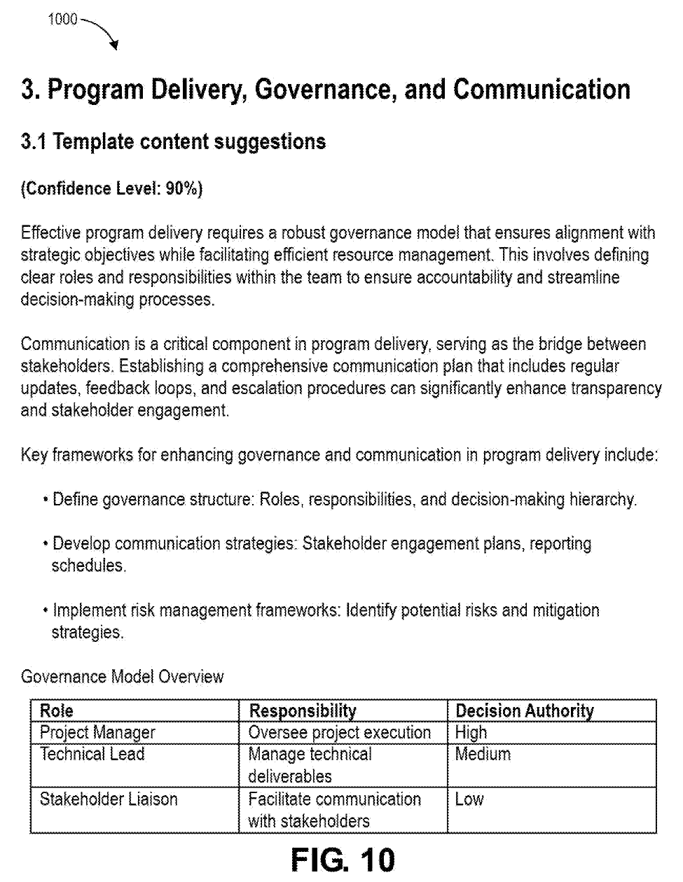

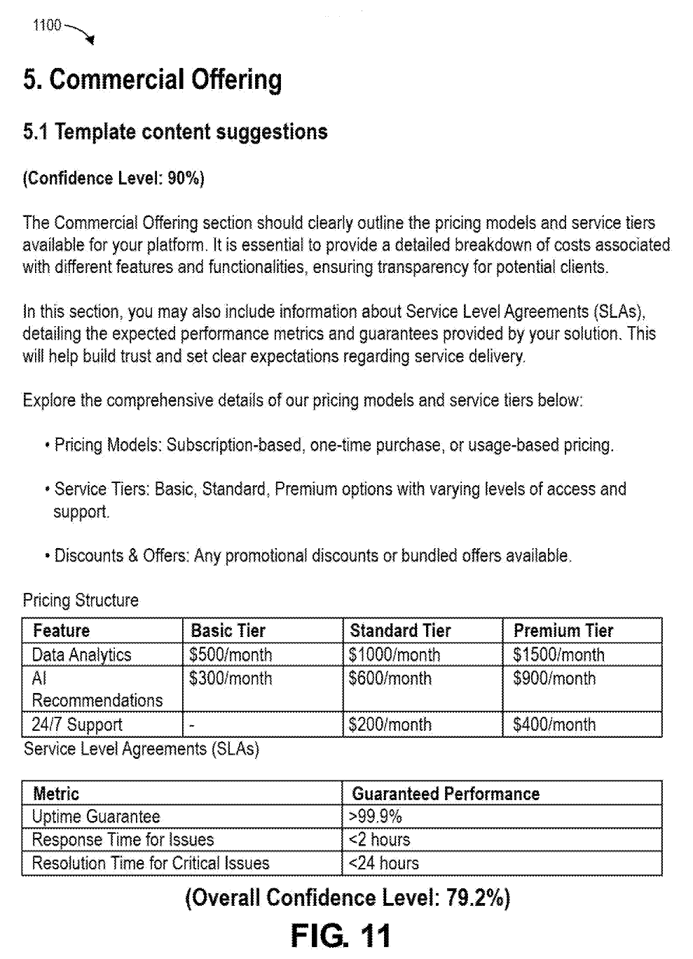

FIGS. 7A, 7B, and 8-11 illustrate example content portions 702, 704, 800, 900, 1000, 1100, in a generated RFP response document, according to an embodiment. Specifically, a portion of the generated RFP response illustrated in FIGS. 7A and 7B includes a product image 702 illustrated together with a related text portion 704. A confidence level is indicated for each generated portion (see FIGS. 7B, and 8-11) and also for the entire document (see FIG. 11), where each confidence level is determined by the multi-agent system and is indicative of a likelihood of accuracy of the corresponding content. The audience of the report may take these confidence levels into account when reviewing the RFP response document.

As disclosed, in some aspects, the structured executive response summary may be generated further based on user input. The user input may include features to be included in the structured executive response summary, cost analysis timeline, and/or audience of the structured executive response summary. In some aspects, generating the structured executive response summary may include assigning an RFP matching score to each product in a product catalogue of a vendor, and selecting products whose RFP matching score is higher than a threshold. The structured executive response summary may highlight portions from the RFP and provide structured textual information for downstream processing.

In some aspects, the method 500 may further include sending the structured executive response summary or an indication of generation of the structured executive response summary to an audience of the structured executive response summary.

In some aspects, the method 500 may further include displaying the structured executive response summary on a user interface of a device associated with the audience of the structured executive response summary.

In some aspects, the method 500 may further include revising the structured executive response summary based on input received from the audience of the structured executive response summary.

In some aspects, the multi-agent system may include a third MLM configured as a master orchestrator agent that decomposes the RFP and plans subtasks for one or more sub-agents (e.g., master orchestrator agent 418), one or more fourth LLMs configured as the sub-agents that each perform an agent-specific task based on a directive received from the master orchestrator agent (e.g., requirements analysis agent 420, technical response drafting agent 424, compliance mapping agent 430, and product matching agent 426), a fifth MLM configured as a context optimization agent (e.g., context optimization component 428) that performs retrieval of domain knowledge from a product catalogue and an image catalogue of a vendor and feeds retrieved domain knowledge to a context window of each sub-agent, and a sixth MLM configured as a response assembly and generation agent (e.g., response assembly and generation engine 422) that assembles response sections generated by the sub-agents. The context window 436 may include an amount of input data that that sub-agent is able to process.

In some aspects, generating the structured executive response summary may include segmenting, by the master orchestrator agent, the processed RFP into logical segments. The logical segments may include a first segment for product aspects, a second segment for financial aspects, a third segment for timelines, and a fourth segment for legal aspects.

In some aspects, generating the structured executive response summary may further include defining, by the master orchestrator agent, a sub-task for each of the sub-agents, wherein each sub-task includes generation of a section of the structured executive response summary.

In some aspects, generating the structured executive response summary may further include assigning, by the master orchestrator agent to each of the sub-agents, one or more of the logical segments that are conceptually related to a task defined for each of the sub-agents.

In some aspects, generating the structured executive response summary may further include combining outputs of the sub-agents by the response assembly and generation agent to generate the structured executive response summary.

In some aspects, the sub-agents may include a requirements analysis agent, a product matching agent, a compliance mapping agent, and a technical response drafting agent.

In some aspects, generating the draft RFP response based on the structured executive response summary may include identifying, by the requirements analysis agent, requests in the RFP that are relevant to a vendor, based on the structured executive response summary.

In some aspects, generating the draft RFP response based on the structured executive response summary may further include identifying, by the technical response drafting agent, response information for the requests based on a contextual analysis. The response information may be structured using a semantic matching mechanism that maps extracted RFP requirements to corresponding entries in a product catalogue of a vendor. The semantic matching mechanism may support response generation across different industries. In some aspects, data structures in the product catalogue may be configurable.

In some aspects, generating the draft RFP response based on the structured executive response summary may include generating, by the response assembly and generation agent, a draft RFP response based on the response information and by using large language model techniques. The draft response may be structured and editable via a user interface. In some aspects, generating the draft RFP response may include integrating relevant product details and automatically attaching associated product images at locations within the draft RFP response (e.g., for enhanced clarity, e.g., see FIGS. 7A and 7B).

In some aspects, a location of a product image in the draft RFP response may be selected based on a confidence score associated with a relevance of the product image to content in the location.

In some aspects, the second MLM may apply NLP techniques and use a product catalogue and an image catalogue of a vendor to ensure consistency, reduce errors, enhance alignment with requirements in the RFP, and verify placement of product images within the finalized RFP response.

In some aspects, the method 500 may further include displaying the finalized RFP response on a user interface.

In some aspects, the method 500 may further include performing an action based on and/or in response to generation of the finalized RFP response. In some aspects, performing the action may include generating and/or transmitting a signal that recommends, instructs, or causes a physical action to occur.

In some aspects, the physical action may include generating a structured briefing report for a business development manager (BDM) based on the finalized RFP response, and transmitting a notification to the BDM to review the finalized RFP response prior to submission to a requester of the RFP, in response to the finalized RFP response indicating completion of all RFP requirements.

In some aspects, the physical action may include generating and transmitting notifications to one or more internal teams, including a notification to an engineering team identifying items in the finalized RFP response that are likely to require new development.

In some aspects, the physical action may include automatically sending the finalized RFP response to a BDM, responsive to generation of the finalized RFP response.

In some aspects, the physical action may include automatically storing the finalized RFP response in an RFP response database of the vendor.

In some aspects, the physical action may include adding metadata to the product catalog and the image catalog, where the metadata identifies a requester of the RFP in products and images that are included in the finalized RFP response.

### Exemplary Computing System

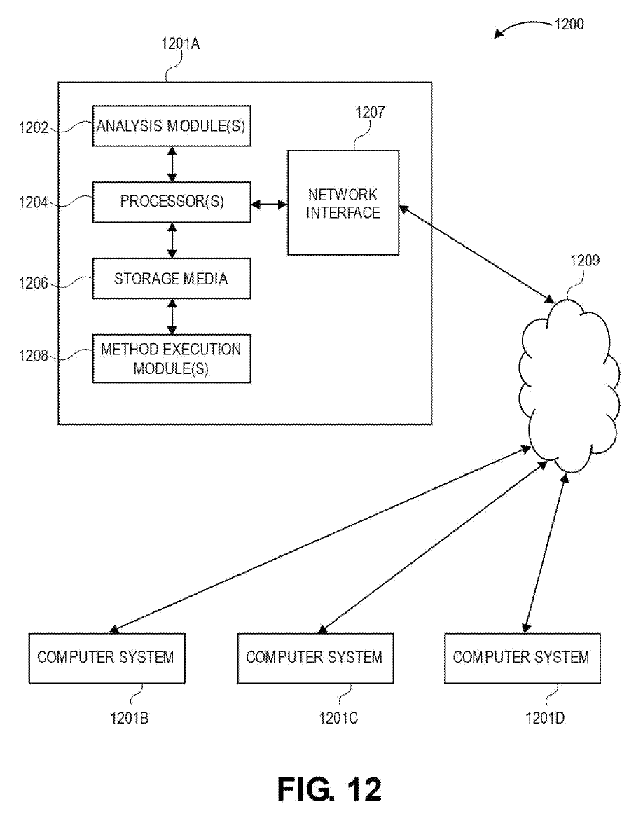

In some embodiments, the methods of the present disclosure may be executed by a computing system. FIG. 12 illustrates an example of such a computing system 1200, in accordance with some embodiments. The computing system 1200 may include a computer or computer system 1201A, which may be an individual computer system 1201A or an arrangement of distributed computer systems. The computer system 1201A includes one or more analysis modules 1202 that are configured to perform various tasks according to some embodiments, such as one or more methods disclosed herein. To perform these various tasks, the analysis module 1202 executes independently, or in coordination with, one or more processors 1204, which is (or are) connected to one or more storage media 1206. The processor(s) 1204 is (or are) also connected to a network interface 1207 to allow the computer system 1201A to communicate over a data network 1209 with one or more additional computer systems and/or computing systems, such as 1201B, 1201C, and/or 1201D (note that computer systems 1201B, 1201C and/or 1201D may or may not share the same architecture as computer system 1201A, and may be located in different physical locations, e.g., computer systems 1201A and 1201B may be located in a processing facility, while in communication with one or more computer systems such as 1201C and/or 1201D that are located in one or more data centers, and/or located in varying countries on different continents).

A processor may include a microprocessor, microcontroller, processor module or subsystem, programmable integrated circuit, programmable gate array, or another control or computing device.

The storage media 1206 may be implemented as one or more computer-readable or machine-readable storage media. Note that while in the example embodiment of FIG. 12 storage media 1206 is depicted as within computer system 1201A, in some embodiments, storage media 1206 may be distributed within and/or across multiple internal and/or external enclosures of computing system 1201A and/or additional computing systems. Storage media 1206 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY^{®} disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 1200 contains one or more method execution module(s) 1208. In the example of computing system 1200, computer system 1201A includes the method execution module 1208. In some embodiments, a single method execution module may be used to perform some aspects of one or more embodiments of the methods disclosed herein. In other embodiments, a plurality of method execution modules may be used to perform some aspects of methods herein.

It should be appreciated that computing system 1200 is merely one example of a computing system, and that computing system 1200 may have more or fewer components than shown, may combine additional components not depicted in the example embodiment of FIG. 12, and/or computing system 1200 may have a different configuration or arrangement of the components depicted in FIG. 12. The various components shown in FIG. 12 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 1200, FIG. 12), and/or through manual control by a user who may make determinations regarding whether a given step, action, template, model, or set of curves has become sufficiently accurate for the evaluation of the subsurface three-dimensional geologic formation under consideration.

The foregoing description, for purposes of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for generating a response to a request for proposal (RFP), the method comprising:
receiving the RFP;
processing the RFP using a first machine learning model (MLM) to produce a processed RFP;
generating, by a multi-agent system, a structured executive response summary based at least on the processed RFP;
generating, by the multi-agent system, a draft RFP response based on the structured executive response summary; and
generating a finalized RFP response by verifying and refining the draft RFP response using a second MLM.

2. The method of claim 1, wherein the RFP is related to an energy industry, wherein the energy industry comprises exploration, drilling, and/or production.

3. The method of claim 1, wherein the RFP is received in natural language.

4. The method of claim 1, wherein the first MLM applies natural language processing (NLP) techniques to perform a contextual analysis on the RFP and uses chained prompting to:
parse the RFP;
extract structured requirements from the RFP; and
tag metadata in the RFP.

5. The method of claim 1, wherein the structured executive response summary is generated further based on user input.

6. The method of claim 1, wherein generating the structured executive response summary is further based on a database that includes a product catalogue and an image catalogue of a vendor, wherein an image in the image catalogue is associated with metadata that associates the image with a product in the product catalogue, wherein the metadata further includes a textual explanation of the image.

7. The method of claim 1, wherein generating the structured executive response summary includes:
assigning an RFP matching score to each product in a product catalogue of a vendor; and
selecting products whose RFP matching score is higher than a threshold.

8. The method of claim 1, wherein the structured executive response summary highlights portions from the RFP and provides structured textual information for downstream processing.

9. The method of claim 1, further comprising:
sending the structured executive response summary or an indication of generation of the structured executive response summary to an audience of the structured executive response summary; and/or
displaying the structured executive response summary on a user interface of a device associated with the audience of the structured executive response summary; and/or
revising the structured executive response summary based on input received from the audience of the structured executive response summary.

10. The method of claim 1, wherein the multi-agent system comprises:
a third MLM configured as a master orchestrator agent that decomposes the RFP and plans subtasks for one or more sub-agents;
one or more fourth LLMs configured as the sub-agents that each perform an agent-specific task based on a directive received from the master orchestrator agent;
a fifth MLM configured as a context optimization agent that performs retrieval of domain knowledge from a product catalogue and an image catalogue of a vendor and feeds retrieved domain knowledge to a context window of each sub-agent; and
a sixth MLM configured as a response assembly and generation agent that assembles response sections generated by the sub-agents.

11. The method of claim 10, wherein generating the structured executive response summary includes:
segmenting, by the master orchestrator agent, the processed RFP into logical segments;
defining, by the master orchestrator agent, a sub-task for each of the sub-agents, wherein each sub-task includes generation of a section of the structured executive response summary;
assigning, by the master orchestrator agent to each of the sub-agents, one or more of the logical segments that are conceptually related to a task defined for each of the sub-agents; and
combining outputs of the sub-agents by the response assembly and generation agent to generate the structured executive response summary.

12. The method of claim 10, wherein the sub-agents include:
a requirements analysis agent;
a product matching agent;
a compliance mapping agent; and
a technical response drafting agent.

13. The method of claim 12, wherein generating the draft RFP response based on the structured executive response summary includes:
identifying, by the requirements analysis agent, requests in the RFP that are relevant to a vendor, based on the structured executive response summary;
identifying, by the technical response drafting agent, response information for the requests based on a contextual analysis, wherein the response information is structured using a semantic matching mechanism that maps extracted RFP requirements to corresponding entries in a product catalogue of a vendor; and
generating, by the response assembly and generation agent, a draft RFP response based on the response information and by using large language model techniques, wherein generating the draft RFP response comprises integrating relevant product details and automatically attaching associated product images at locations within the draft RFP response.

14. The method of claim 13, wherein a location of a product image in the draft RFP response is selected based on a confidence score associated with a relevance of the product image to content in the location.

15. The method of claim 1, wherein the second MLM applies NLP techniques and uses a product catalogue and an image catalogue of a vendor to ensure consistency, reduce errors, enhance alignment with requirements in the RFP, and verify placement of product images within the finalized RFP response.

16. The method of claim 1, further comprising displaying the finalized RFP response on a user interface.

17. The method of claim 1, further comprising performing an action based on and/or in response to generation of the finalized RFP response, wherein performing the action comprises generating and/or transmitting a signal that recommends, instructs, or causes a physical action to occur.

18. The method of claim 17, wherein the physical action comprises:
generating a structured briefing report for a business development manager (BDM) based on the finalized RFP response, and transmitting a notification to the BDM to review the finalized RFP response prior to submission to a requester of the RFP, in response to the finalized RFP response indicating completion of all RFP requirements; and/or
generating and transmitting notifications to one or more internal teams, comprising a notification to an engineering team identifying items in the finalized RFP response that are likely to require new development.

19. A computing system, comprising:
one or more processors; and
a memory system comprising one or more non-transitory computer-readable media storing instructions that, when executed by at least one of the one or more processors, cause the computing system to perform operations for generating a response to a request for proposal (RFP), the operations comprising:
receiving the RFP;
processing the RFP using a first machine learning model (MLM) to produce a processed RFP;
generating, by a multi-agent system, a structured executive response summary based at least on the processed RFP;
generating, by the multi-agent system, a draft RFP response based on the structured executive response summary; and
generating a finalized RFP response by verifying and refining the draft RFP response using a second MLM.

20. A non-transitory computer-readable medium storing instructions that, when executed by one or more processors of a computing system, cause the computing system to perform operations for generating a response to a request for proposal (RFP), the operations comprising:
receiving the RFP;
processing the RFP using a first machine learning model (MLM) to produce a processed RFP;
generating, by a multi-agent system, a structured executive response summary based at least on the processed RFP;
generating, by the multi-agent system, a draft RFP response based on the structured executive response summary; and
generating a finalized RFP response by verifying and refining the draft RFP response using a second MLM.
